(19) United States
(12) Patent Application Publication
(10) Pub. No.: US 2017/0178192 A1
(43) Pub. Date: Jun. 22, 2017

(54) DELIVERY SYSTEM OF EVENT INFORMATION OF STORE/BUSINESS OPENING DAY, ANNIVERSARY DAY AND STORE/BUSINESS CLOSING DAY

(71) Applicant: HANGAR CO., LTD., Osaka-shi, Osaka (JP)

(72) Inventor: Yutaka HIRAHARA, Osaka-shi, Osaka (JP)

(21) Appl. No.: 15/316,516

(22) PCT Filed: Jun. 8, 2015
(86) PCT No.: PCT/JP2015/067099

§ 371 Date: Dec. 6, 2016

(30) Foreign Application Priority Data
Jun. 9, 2014 (JP) 2014-118753

(51) Int. Cl. G06Q 30/02; G06Q 10/10

(52) U.S. Cl. CPC G06Q 30/0264; G06Q 10/1095; G06Q 30/0277

(57) ABSTRACT

The present invention provides a delivery system for easily collecting/notifying a store/business opening day, anniversary day, or store/business closing day of a company, store and other organizations. In the delivery system, a server accepts, from a sponsor-side communication device, date information regarding any of the store/business opening day and the anniversary day, and an event information of the memorial day. The server calculates the information of the anniversary day for the next and subsequent years based on the date of the store/business opening day. For the store opening day registered in the server by a person opening a new store, the anniversary day is registered by the server, and the registered day is updated for the next and subsequent years when the anniversary day of an existing store is registered. The server accepts the transmission of a keyword from a user-side communication device and searches for a sponsor. The server responds to the user-side communication device with a website for delivering a store-closing information or a website for delivering information about an anniversary or a store-opening day in accordance with the updating status of the event information of the anniversary day.

### TECHNICAL FIELD

The present invention relates to a technology of delivering a date of a store/business opening day, an anniversary day, a store/business closing day of a company, a store or other organizations and an event information (e.g. auspicious event) corresponding to the date.

### BACKGROUND ART

In conventional business practices, the company, the store or other organizations often plan a bargain sale related to the opening day for customers under the name of “opening celebration” or the like. In addition, in the anniversary day, which is the date after a predetermined number of years from the opening day, a bargain sale, a book publishing and other various events are often planned for celebrating the anniversary day under the name of “first anniversary after the opening” and “10 years celebration,” for example. Furthermore, when the opened store is closing or the store is moving to open the store again, the event related thereto is planned. Such practice has already been established in the society in general.

As described above, same as a birth day of the individual and a ceremony of funerals, weddings, and other ceremonial occasions, the company, the store or other organizations perform, on the memorial day, the event related to various memorial days such as the opening day, anniversary day, closing day and the moving day to use memorial day as business opportunities. Such business practice has already been established.

Patent document 1 discloses a ceremonial occasion support system for supporting various actions related to the ceremonial occasion such as a decision on the time of celebration, the amount of congratulatory money, relief money, condolence money or the like.

### PRIOR ART DOCUMENTS

### Patent Documents

[Patent document 1] Japanese Unexamined Patent Application Publication No. 2010-218079

### DISCLOSURE OF THE INVENTION

### Problems to be Solved by the Invention

However, it is not easy to widely advertise and notify the business opportunities of the event related to the memorial day of the company, the store and other organizations. For example, the event information can be uploaded on the website of the store or other organizations, a poster can be displayed on the actual store, and print media can be distributed as the method of notifying the event information. However, the effect of uploading the website is small when the number of page views of the website of the store is relatively small. Further, the poster displayed on the actual store and the distribution of the print media are not enough as the notifying method. Accordingly, a business model for efficiently delivering the event information (e.g. auspicious event) performed corresponding to the date of the new store/business opening day (Grand Open Day), the anniversary day (OpenDay-th) and the store/business closing day (Close Day) of the company, the store or other organizations is needed.

The present invention aims for providing a delivery system that can easily delivers the information of the memorial day such as the opening day, the anniversary day, the closing day or the like of newly opening company, store or other organizations.

### Means for Solving the Problem

In one embodiment, a delivery system includes a server, a sponsor terminal and a user terminal. The server includes: a communication interface for accepting an access from the sponsor terminal or the user terminal to transmit/receive data to/from the sponsor terminal or the user terminal; a memory for storing, in a respective cell of dates of a calendar, an information identifying a sponsor, an information of a store/business opening day of the sponsor, an event information of the store/business opening day, and an event information of an anniversary date of the next and subsequent years of the store/business opening day, the information identifying the sponsor and the information of the store/business opening day of the sponsor being in association with each other; and a first processor for controlling an operation of the server and transmitting the event information to the user terminal. The sponsor terminal includes: an input interface for receiving an input operation to register in the server the information identifying the sponsor, the information of the store/business opening day of the sponsor, the event information of the store/business opening day to be delivered to the user terminal; and a communication unit for transmitting contents registered by the input operation to the server. The user terminal includes: a display; a communication section; and a second processor for controlling an operation of the user terminal. The first processor of the server has functions of: a registration processing section for receiving the information of the store/business opening day from the sponsor terminal, recording a date of the store/business opening day and the information identifying the sponsor in the memory in association with each other, specifying the anniversary date of at least the next and subsequent years of the store/business opening day by calculation, and recording the specified anniversary information indicating the anniversary date in the cell of the dates of the calendar; a store opening information delivery section for transmitting the information of the store/business opening day, the information identifying the sponsor related to the store/business opening day and the event information of the store/business opening day to the user terminal; and an anniversary information delivery section for transmitting the anniversary information and the event information of the anniversary date to the user terminal. The second processor of the user terminal has functions of: a reception processing section for receiving the information of the store/business opening day and the anniversary information from the server; and a display processing section for displaying the received information on the display.

In another embodiment, the first processor of the server has a function of a store closing information delivery section for transmitting an information indicating a possibility of closing store/business of the sponsor to the user terminal when the input operation of the event information is not received from the sponsor terminal for a predetermined period of time. The reception processing section of the second processor of the user terminal has a function of receiving the information indicating the possibility of closing store/business of the sponsor. The display processing section has a function of displaying the information indicating the possibility of closing store/business on the display.

### Effects of the Invention

In one embodiment described above, the company, the store and other organizations can let users easily search and know the memorial day such as the store/business opening day and the anniversary day.

In one embodiment described above, when the server does not receive the renewal operation of the event information from the sponsor terminal for a predetermined period of time, the information indicating a possibility of closing store/business of the sponsor is transmitted to the user terminal. Accordingly, in one embodiment described above, when the renewal operation of the event information is not updated by the sponsor side for a predetermined period of time, the closing of the store of the sponsor can be automatically informed to the users by notifying that there is a possibility of closing store. Thus, convenience can be increased both for the sponsor and the user.

The above described or other purposes, features, aspects and advantages of the present invention will be revealed from the following detailed explanation realized in association with the attached drawings.

### BRIEF DESCRIPTION OF THE DRAWINGS

FIG. 1 is a drawing showing a configuration of a delivery system of the embodiment.

FIG. 2 is a block diagram showing a configuration of a sponsor-side communication device 10A.

FIG. 3 is a block diagram showing a configuration of a server 20A.

FIG. 4 is a block diagram showing a configuration of a user-side communication device 30A.

FIG. 5 is a drawing showing a data structure of a sponsor management information 261.

FIG. 6 is a drawing showing a data structure of a user management information 264.

FIG. 7 is a drawing showing a data structure of a calendar information 266.

FIG. 8 is a flowchart showing a process that the sponsor-side communication device 10A registers an information of a sponsor (information identifying a sponsor) on the server 20A.

FIG. 9 is a flowchart showing a process that the user-side communication device 30A searches the sponsor in a server 20 and a process that the server 20 responses the search result to the user-side communication device 30A.

FIG. 10 is a flowchart showing a process of updating the information of the store/business opening day when the sponsor changes the location and the server 20 receives the registration of change from the sponsor-side communication device 10A.

FIGS. 11A and 11B are drawings showing an example of an interface displayed on a display 104 when the sponsor-side communication device 10A registers the information of the sponsor on the server 20A.

FIGS. 12A and 12B are drawings showing an example of an interface displaying the information of the store/business opening day and an interface displaying the information of the anniversary day after a user-side communication device 30 acquires the information of the sponsor.

FIGS. 13A and 13B are drawings showing an example of an interface displaying the information of the store/business closing day and an interface displaying a tracking information after the user-side communication device 30 acquires the information of the sponsor.

FIGS. 14A to 14D are drawings showing an example of a website responded from the server 20 to the user-side communication device 30 according to an update status of the sponsor.

### MODES FOR CARRYING OUT THE INVENTION

Hereafter, the embodiments of the present invention will be explained with reference to the drawings. In the explanation below, the same reference numerals are applied to the same elements in the drawings. The names and functions of the same elements are also same. Accordingly, detailed explanation will not be repeated for the same elements.

### Embodiments

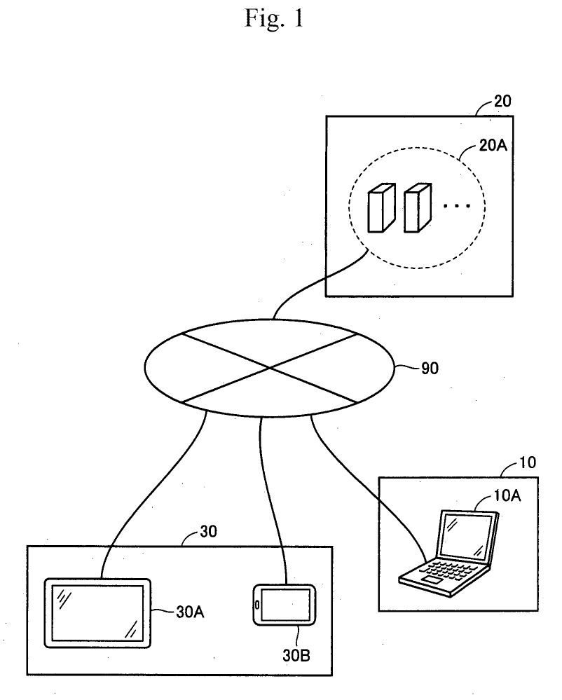

FIG. 1 is a drawing showing a configuration of a delivery system of the embodiment. As shown in FIG. 1, the delivery system includes a sponsor-side communication device 10, a server 20 and a user-side communication device 30. These devices are connected by a network 90 to communicate with each other.

In the example of FIG. 1, a sponsor-side communication device 10A, which is a laptop-type information processing device, is shown as the sponsor-side communication device 10. In addition, a server 20A formed by a plurality of servers is shown as the server 20. The server 20A has a function of a DBMS (database management system) for managing the database. Further, a user-side communication device 30A, which is a tablet-type information processing device, and a user-side communication device 30B, which is a smart phone, are shown as the user-side communication device 30.

The sponsor-side communication device 10 is an information processing device operated by relevant people of a company, a store or other organizations. (Hereafter, a sender who transmits the information to the user-side communication device 30 via the server 20 is also called “sponsor.” For example, the sponsor-side communication device 10 receives an input operation of an owner of the store to register an event (e.g. sales promotion plan such as bargain sale plan) related to the memorial day of the anniversary of the store on the server 20 and transmit the information to consumers via the server 20. The sponsor-side communication device 10 transmits the received contents of the input operation to the server 20. In addition, the sponsor-side communication device 10 receives an input operation of the owner of the store or other organizations to register the date of store/business-closing on the server 20 and transmit the information of the store/business-closing to external devices such as the user-side communication device 30 and the sponsor-side communication device 10 via the server 20. Further, the sponsor-side communication device 10 receives a registration from a sponsor who newly wants to open store/business. For example, an operation to specify an area to open the store/business and an operation to acquire the information of the store/business-closing provided by the server 20 are received.

The server 20 accepts an access from the sponsor-side communication device 10 and the user-side communication device 30 to function as a server to manage a plurality of websites. For example, the server 20 manages the websites of: (1) a website showing a store/business opening day information to transmit the information of the store/business opening day of the company, the store or other organizations; (2) a website showing an anniversary information to transmit the information of the anniversary which shows a date after a predetermined number of years of the store/business opening day; (3) a website showing a store/business closing day information which shows the store/business closing day of them; (4) a website showing a tracking information which shows a follow-up information of the closed store or other organizations (e.g. new location, change in business category, information of human resources after closing); and (5) a website providing a platform facilitating and mediating a transaction between a business operator closing the store/business and a person who wants to obtain a property such as a store and fixtures and equipments used in the store. The server 20 manages these websites and transmits the event information related to the store/business opening day, the anniversary day, the store/business closing day of the store or other organizations to the user-side communication device 30. Thus, the server 20 provides a transaction function of the property, the equipments and other things in accordance with the closing of the store or other organizations.

In addition, the server 20 can be formed by a plurality of information processing devices. The server 20 can communicate with an external server. For example, the server 20 can include a server holding a telephone directory database in which the information of the sponsors such as names, locations and telephone numbers of the sponsors are stored. Alternatively, the server 20 can communicate with an external server holding the above described telephone directory database, or the server 20 can receive the information about the sponsors by making an access to the external server.

The user-side communication device 30 makes an access to the server 20, acquires the information of various memorial days of the store or other organizations and the even information related to the memorial days, and displays the information on the display.

### <A. Configuration>

The configuration of the sponsor-side communication device 10, the server 20 and the user-side communication device 30 included in the delivery system will be explained.

### <A1. Configuration of Sponsor-Side Communication Device 10>

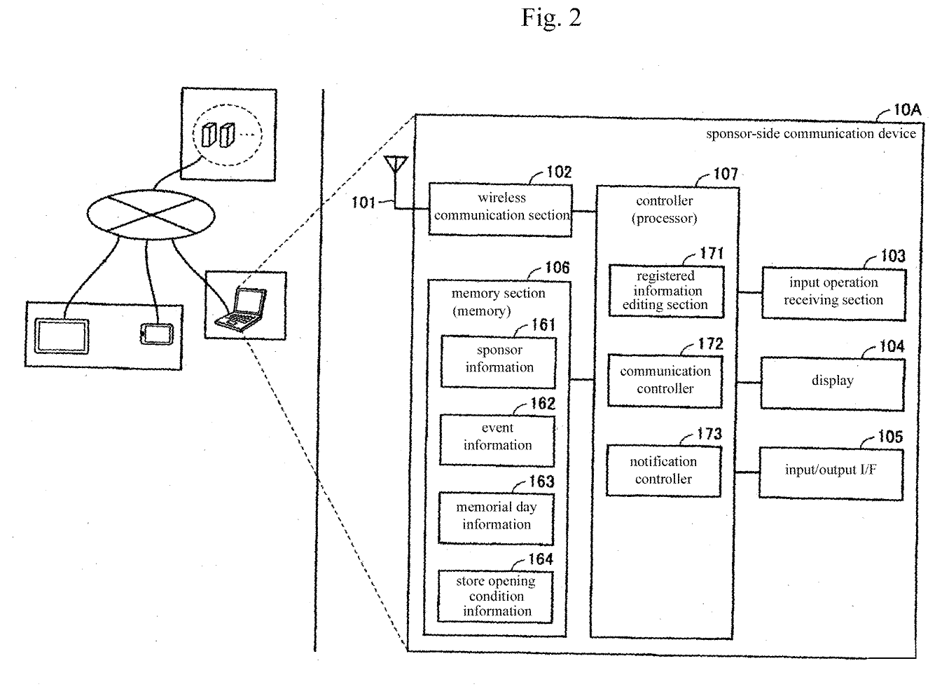

FIG. 2 is a block diagram showing a configuration of the sponsor-side communication device 10A. As shown in FIG. 2, the sponsor-side communication device 10A includes an antenna 101, a wireless communication section 102, an input operation receiving section 103, a display 104, an input/output I/F (interface) 105, a memory section 106 and a controller 107.

The antenna 101 radiates a signal output from the sponsor-side communication device 10A to a space as radio waves. In addition, the antenna 101 receives radio waves from a space and gives the received signal to the wireless communication section 102. The wireless communication section 102 executes modulation/demodulation processing and other processing so that the sponsor-side communication device 10A communicates with other communication devices and transmits/receives signals via the antenna 101 or the like. The wireless communication section 102 includes a tuner and a high-frequency circuit, for example. The wireless communication section 102 is a communication module for wireless communication. The wireless communication section 102 modulates and demodulates the wireless signals transmitted and received by the sponsor-side communication device 10A, converts a frequency of the signals, and gives the received signals to the controller 107. The input operation receiving section 103 receives an input operation of the relevant people of the sponsor side. The input operation receiving section 103 is realized, for example, by various input devices such as a keyboard, a track pad and a touch panel.

The display 104 displays a menu screen and a user interface for editing the event information to be transmitted to users of the customer side by the operation of application programs in the sponsor-side communication device 10A. The display 104 is achieved, for example, by an LCD (Liquid Crystal Display). An organic EL (electroluminescence) display and other display devices can be also used for achieving the display 104. The input/output I/F 105 is a general purpose interface for connecting the sponsor-side communication device 10A with various devices. The memory section 106 is formed by a flash memory or a RAM (Random Access Memory), for example. The memory section 106 memorizes data and programs used by the sponsor-side communication device 10A. In a certain aspect, the memory section 106 memorizes a sponsor information 161, an event information 162, a memorial day information 163 and a store opening condition information 164.

The sponsor information 161 is an information including attributes of the sponsor (e.g. store) or the like who operates the sponsor-side communication device 10A. For example, the sponsor information 161 includes the information of the name of the store of the sponsor, the location of the store of the sponsor and the classification of the business category of the sponsor (category of the business such as restaurant business).

The event information 162 is an information showing a plan of sales promotion and the like, the plan being related to the memorial days such as the store/business opening day, the anniversary day and the store/business closing day of the store or other organizations. The sponsor-side communication device 10A receives an input operation of the event information related to the memorial days of the sponsor and records the received information as the event information 162. The memorial day information 163 is an information showing the date of the memorial day such as the store/business opening day of the sponsor (e.g. store). The store opening condition information 164 is an information showing a condition of opening store/business specified by the sponsor when the sponsor plans to newly open the store/business. For example, the store opening condition information 164 includes a condition of the area to open the store, a condition of the business category of the store, the date of opening store/business and other conditions.

The controller 107 controls an operation of the sponsor-side communication device 10A by reading the control programs memorized in the memory section 106 and executing the control programs. The controller 107 is, for example, an application processor. The controller 107 operates in accordance with the programs and functions as a registered information editing section 171, a communication controller 172 and a notification controller 173.

The registered information editing section 171 receives the registration of the attributes of the sponsor (e.g. store) by the input operation receiving section 103, and updates the sponsor information 161 memorized in the memory section 106. In addition, the registered information editing section 171 receives the registration of the event information, the information of the date of the memorial day, the information of the condition of opening store/business and other information by the input operation receiving section 103, and updates the event information 162, the memorial day information 163 and the store opening condition information 164 memorized in the memory section 106. The communication controller 172 controls the process of transmitting the data indicating the contents of the input operation of the relevant people of the sponsor side to the server 20A. The data includes the sponsor information 161, the event information 162, the memorial day information 163 and the store opening condition information 164, for example. The notification controller 173 receives the notification from the server 20A or other devices and notifies the content of the notification by the display 104 or the like.

Note that the sponsor-side communication device 10A can have a LAN (Local Area Network) port or the like to communicate with other communication devices by wired connection without limited to the wireless communication using the antenna 101 or the like.

### <A2. Configuration of Server 20>

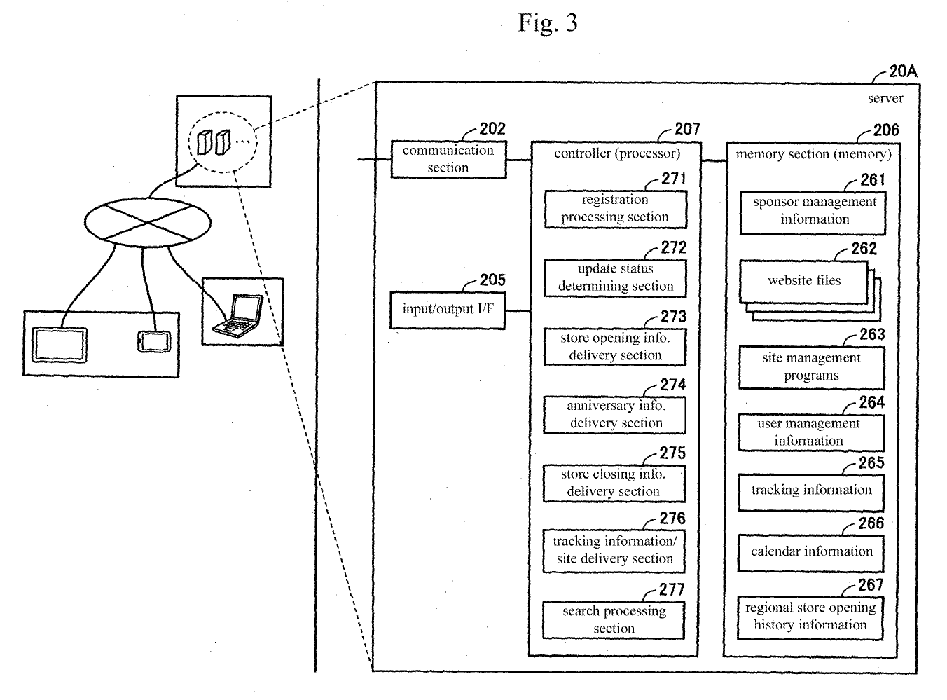

FIG. 3 is a block diagram showing a configuration of the server 20A. As shown in FIG. 3, the server 20A includes a communication section 202, an input/output I/F 205, a memory section 206 and a controller 207.

The communication section 202 is a communication interface for executing modulation/demodulation processing to transmit/receive signals so that the server 20A can be used with other communication devices. The input/output I/F 205 is a general purpose interface for connecting the server 20A with various devices. The memory section 206 is formed by a flash memory, a HDD (Hard Disk Drive) or a RAM (Random Access Memory), for example. The memory section 206 stores the programs used by the server 20A and various data used by the server 20A. In a certain aspect, the memory section 206 memorizes a sponsor management information 261, website files 262, a site management program 263, a user management information 264, a tracking information 265, a calendar information 266 and a regional store opening history information 267.

The sponsor management information 261 is an information for managing the sponsor (e.g. store). The sponsor management information 261 includes an information identifying the sponsor (e.g. store), an information indicating the memorial days of the sponsor such as the store/business opening day, the anniversary day and the store/business closing day, and the event information related to the memorial days such as the store/business opening day, the anniversary day and the store/business closing day. The details will be described later. The server 20A is connected to the sponsor-side communication device 10A, and updates the sponsor management information 261 in accordance with the input operation of the sponsor information, the information of the memorial day and the event information input from the user into the sponsor-side communication device 10A. The website files 262 are data files such as images and texts to be used in a plurality of websites managed by the server 20A. The site management program 263 is a program such as a CMS (Content Management System) used for managing the configuration of the website and the like by the administrator of the website.

The user management information 264 is an information for managing the consumer-side users using the web site managed by the server 20A. The user management information 264 includes an information for identifying the consumer-side users, an information for specifying the sponsor (e.g. store) used by the users, history of access to the website by the users. The details will be described later. The tracking information 265 is an information showing a follow-up information (e.g. new location, change in business category, information of human resources after closing) of the closed sponsor (e.g. store) when the sponsor is closed.

The calendar information 266 is an information having 365 cells according to the date of the calendar of each year so that the sponsor information including the information of the memorial days such as the store/business opening day, anniversary day and the store/business closing day is stored in the cell corresponding to the date of each of the memorial days. The server 20A updates the sponsor management information 261 based on the information transmitted from the sponsor-side communication device 10A, and sequentially (e.g. every day) updates the calendar information 266 based on the information indicated in the updated sponsor management information 261. For example, when the server 20A receives the search criteria specifying the date from the user-side communication device 30A, the server 20A refers to the calendar information 266 and responses the information of the sponsor having the memorial day corresponding to the specified date to the user-side communication device 30A.

The regional store opening history information 267 is an information showing a history of opening the store or the like for each region. The server 20A receives the registration of the sponsor information such as the store/business opening day and the location of each sponsor, and generates the history of the opening/closing store/business of each sponsor respectively for each region based on the received information.

The controller 207 controls an operation of the server 20A by reading and executing the control programs memorized in the memory section 206. The controller 207 is achieved, for example, by a plurality of processors. The controller 207 operates in accordance with the programs and functions as a registration processing section 271, an update status determining section 272, a store opening information delivery section 273, an anniversary information delivery section 274, a store closing information delivery section 275, a tracking information/site delivery section 276 and a search processing section 277.

The registration processing section 271 receives the contents of the input operation from the sponsor-side communication device 10A for registering the sponsor information on the sponsor management information 261, and controls a process of updating the sponsor management information 261 and a process of updating the calendar information 266. For example, the server 20A receives the registration of the information identifying the sponsor and the information of the store/business opening day from the sponsor-side communication device 10A, calculates the anniversary day after a predetermined number of years of the store/business opening day of the sponsor, and registers the store/business opening day of the sponsor and the calculated anniversary day on the sponsor management information 261. In addition, the server 20A receives the date of the anniversary and the number of years after the store/business opening day from the sponsor (e.g. existing store), and registers the received information of the anniversary day on the sponsor management information 261. Further, the server 20A receives the information of the store/business closing day from the sponsor, and registers the received information of the store/business closing day on the sponsor management information 261.

According to the access from the user-side communication device 30A, the update status determining section 272 judges whether or not the event information of the sponsor responded to the user-side communication device 30A is updated within a predetermined period of time before the time of the access of the user-side communication device 30A. In other words, the update status determining section 272 judges whether or not the update status of the event information updated by the sponsor-side communication device 10A satisfies a predetermined condition. For example, when the event information is not updated within a predetermined period (e.g. two weeks or one month) before the date of the memorial day of the anniversary day of the sponsor, there is a possibility that the store of the sponsor is closed. In this case, the server 20A responses the website showing the store/business closing day of the sponsor to the user-side communication device 30A.

According to the access from the user-side communication device 30A, the store opening information delivery section 273 delivers the information of the store/business opening day by replying the website showing the information of the store/business opening day to the user-side communication device 30A. Thus, the information of the store/business opening day of the company, the store or other organizations is delivered. According to the access from the user-side communication device 30A, the anniversary information delivery section 274 delivers the information of the anniversary day by replying the website showing the information of the anniversary to the user-side communication device 30A. Thus, the information of the anniversary showing the date after a predetermined number of years of the store/business opening day of the company, the store or other organizations is delivered. According to the access from the user-side communication device 30A, the store closing information delivery section 275 delivers the information of the store/business closing day by replying the website showing the information of the store/business closing day of the company, the store or other organizations to the user-side communication device 30A.

According to the access from the user-side communication device 30A, the tracking information/site delivery section 276 delivers the tracking information by replying the website showing the tracking information indicating the follow-up information (e.g. new location, change in business category, information of human resources after closing) of the closed store or the like to the user-side communication device 30A. In addition to the website showing the tracking information, the tracking information/site delivery section 276 delivers an information (e.g. URL: Uniform Resource Locator) of the website (e.g. auction site) to external devices (devices such as the sponsor-side communication device 10 and the user-side communication device 30) so as to provide a platform for connecting the owner of the unoccupied property, equipments and other things which become unnecessary when closing the store with another business operator who wants to use the property and acquire the equipments. The search processing section 277 receives a keyword for searching the sponsor information from the user-side communication device 30A and searches the sponsor based on the keyword. As the keyword for searching the sponsor information, the name of the store of the sponsor, the location of the sponsor and an arbitrary keyword for searching the business category/business type can be used, for example.

### <A3. Configuration of User-Side Communication Device 30>

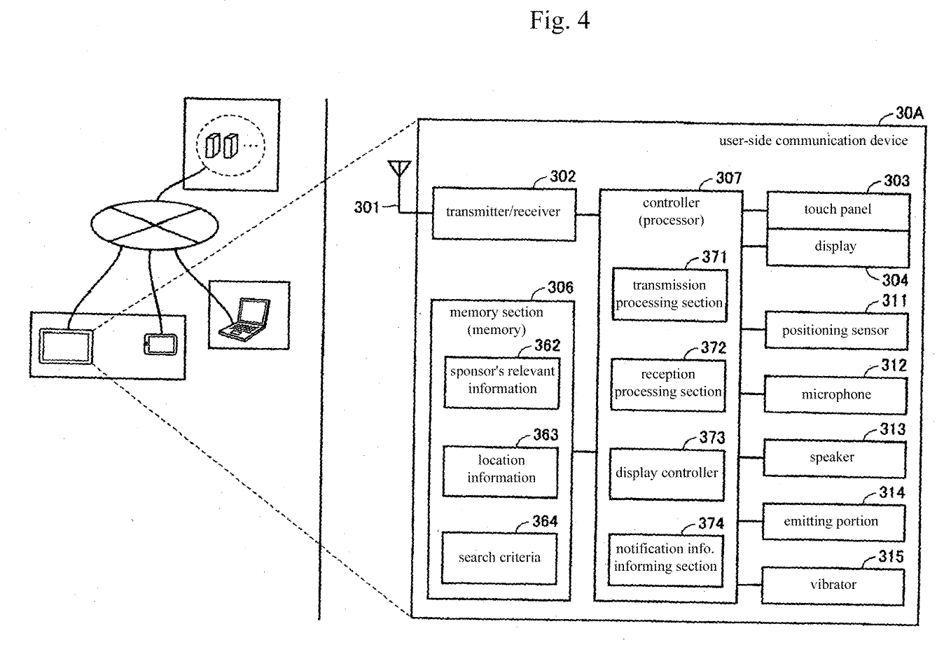

FIG. 4 is a block diagram showing a configuration of the user-side communication device 30A. As shown in FIG. 4, the user-side communication device 30A includes an antenna 301, a transmitter/receiver 302, a touch panel 303, a display 304, a memory section 306, a controller 307, a positioning sensor 311, a microphone 312, a speaker 313, an emitting portion 314 and a vibrator 315.

The antenna 301 radiates a signal output from the user-side communication device 30A as radio waves. In addition, the antenna 301 receives radio waves from a space and gives the received signal to transmitter/receiver 302. The transmitter/receiver 302 is a communication interface to execute modulation/demodulation processing and other processing so that the user-side communication device 30A is used with other communication devices and transmits/receives signals. The touch panel 303 receives an input operation of the consumer-side users. The touch panel 303 receives a touch operation of the user by using, for example, an electrostatic capacity type. The touch panel 303 outputs the input operation of the consumer-side users to the controller 307. The display 304 is achieved, for example, by an LCD. The display 304 displays the files received from the server 20A by the user-side communication device 30A.

The memory section 306 is formed by a flash memory or a RAM, for example. The memory section 306 memorizes programs used by the user-side communication device 30A and various data received from the server 20A by the user-side communication device 30A. In a certain aspect, the memory section 306 memorizes a sponsor's relevant information 362, a location information 363 and search criteria 364. The sponsor's relevant information 362 indicates an information related to the sponsor. For example, the sponsor's relevant information 362 is an information indicating the sponsor registered as favorite setting or the like by the user of the user-side communication device 30A.

The location information 363 is an information showing the location of the user-side communication device 30A. For example, the user-side communication device 30A obtains a latitude and a longitude of the user-side communication device 30A by the positioning sensor 311, and the location of the user-side communication device 30A is memorized as the location information 363 based on the obtained latitude and longitude. The search criteria 364 is a search criteria for the user of the user-side communication device 30A to search the sponsor in the server 20A. For example, the user-side communication device 30A memorizes the keyword for searching frequently-used keyword used by the user of the user-side communication device 30A as the search criteria 364.

The controller 307 controls an operation of the user-side communication device 30A by reading and executing the control programs memorized in the memory section 306. The controller 307 is achieved by an application processor. The controller 307 operates in accordance with the programs and functions as a transmission processing section 371, a reception processing section 372, a display processing section 373 and a notification information informing section 374.

The transmission processing section 371 controls a process of establishing communication connection between the user-side communication device 30A and the server 20A and a process of transmitting the data from the user-side communication device 30A to the server 20A. The reception processing section 372 controls a process of establishing communication connection between the user-side communication device 30A and the server 20A and a process of transmitting the data from the server 20A to the user-side communication device 30A. The display processing section 373 performs a process of displaying the data received by the user-side communication device 30A from the server 20A on the display 304.

The notification information informing section 374 performs a process of notifying the notification received by the user-side communication device 30A from the server 20A using the display 304, the speaker 313, the emitting portion 314, the vibrator 315 or other device. For example, when the user performs a process of preliminarily specifying the specific sponsor on the server 20A and the event information of the specified sponsor is updated, the notification indicating the update is notified from the server 20A to the user-side communication device 30A, and the user-side communication device 30A notifies the user using the display 304 or the like.

The positioning sensor 311 is a sensor for measuring the location of the user-side communication device 30A. For example, the positioning sensor 311 is a GPS (Global Positioning System) module. The microphone 312 functions as a sound input section to receive an input of sound signals and output the sound signals to the controller 307. The speaker 313 functions as a sound output section to output the sound signals to the outside of the user-side communication device 30A. The emitting portion 314 is formed, for example, by an LED (Light Emitting Diode). The emitting portion 314 emits light in accordance with the control of the controller 307. The vibrator 315 vibrates the user-side communication device 30A by the drive of a motor in accordance with the control of the controller 307.

### <B. Data Structure>

Then, the data structure of various data used in the delivery system will be explained.

### <B1. Data Structure of Sponsor Management Information 261>

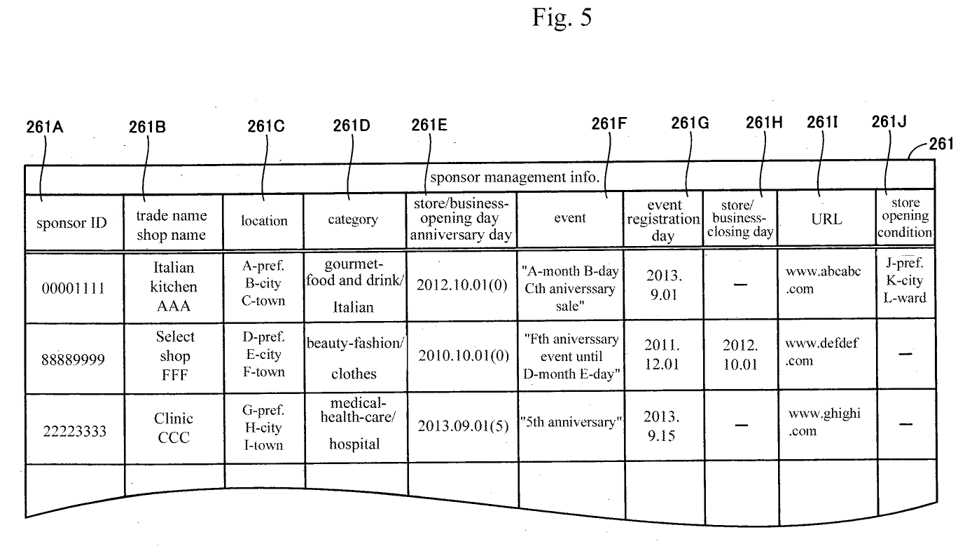

FIG. 5 is a drawing showing a data structure of the sponsor management information 261. As shown in FIG. 5, the sponsor management information 261 memorized in the memory section 206 of the server 20A includes a sponsor identification information 261A, a store/business-name information 261B, a location 261C, a category 261D, a store/business opening day/anniversary day 261E, an event information 261F, an event registration day 261G a store/business closing day 261H, a URL 261I and a store opening condition 261J.

The sponsor identification information 261A indicates an information for identifying each sponsor. The store/business-name information 261B indicates a name such as a trade name and a shop name of each sponsor. The location 261C indicates a location (e.g. address of the store) related to the sponsor.

The category 261D indicates a category of the business of the sponsor. For example, the category 261D includes a large classification such as a category of “gourmet-food and drink” and a category of “beauty-fashion” and more detailed category (small classification) such as a sub-category of “Italian” under the category of “gourmet/food and drink” and a sub-category of “clothes” under the category of “beauty/fashion.”

The store/business opening day/anniversary day 261E indicates the opening day of the sponsor or the anniversary day registered by the sponsor on the server 20 as an initial registration. For example, when registering the anniversary day, in addition to the date of the opening day or the initial registration of the anniversary day of the sponsor, the server 20 receives an information indicating the number of the anniversary year from the sponsor-side communication device 10 and memorizes the number in the store/business opening day/anniversary day 261E. For example, in the store/business opening day/anniversary day 261E, the date “yyyy. mm. dd” means dd-th day of mm-th month in the year of yyyy. If the number in parentheses is a value “0,” it means the store/business opening day. If the number in parentheses is a value “1” or larger, it means the number of the anniversary year. For example, in the store/business opening day/anniversary day 261E, if the date is indicated as “2012. 10. 01” and the anniversary year is indicated as “(0),” it means that the store/business opening day of the sponsor is Oct. 1, 2012. Alternatively, in the store/business opening day/anniversary day 261E, if the date is indicated as “2013. 09. 01” and the anniversary year is indicated as “(5),” the server 20 receives the initial registration of Sep. 1, 2013 as the fifth anniversary day from the sponsor.

The event information 261F indicates the event information related to the store/business opening day, the anniversary day and the store/business closing day to be delivered from the sponsor to the customer or the like. The event registration day 261G indicates a day when the sponsor updates the event information shown in the event information 261F.

The store/business closing day 261H indicates a day when the sponsor closes the store/business. The URL 261I indicates an information of an access destination for accessing the web page showing the information of the sponsor. The store opening condition 261J indicates a condition of opening store/business specified by the sponsor when the sponsor newly plans to open the store or the like. In the example shown in FIG. 5, the sponsor specifies the condition of the location of the store opening condition 261J as “J-prefecture, K-city and L-ward.”

### <B2. Data Structure of User Management Information 264>

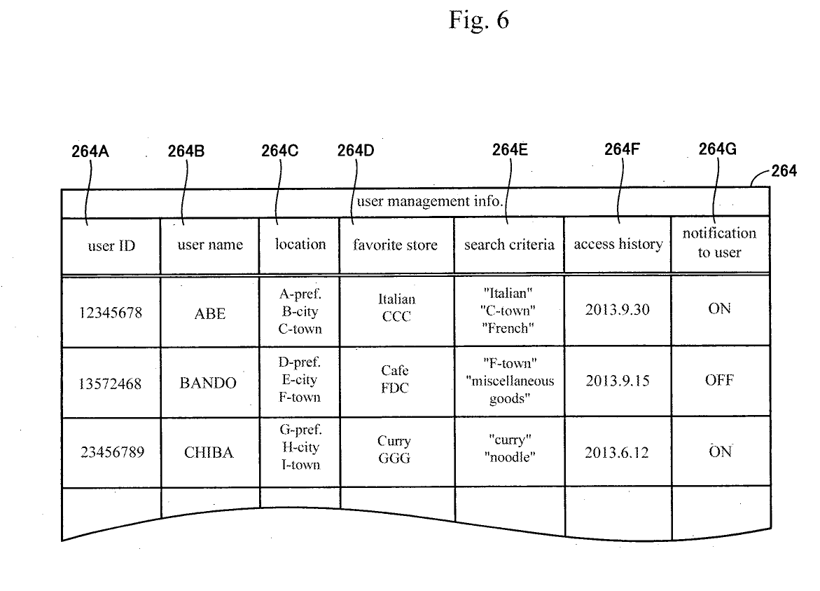

FIG. 6 is a drawing showing a data structure of the user management information 264. As shown in FIG. 6, the user management information 264 memorized in the memory section 206 of the server 20A includes a user identification information 264A, a user name 264B, a location 264C, a favorite store information 264D, a search criteria 264E, an access history 264F and a notification 264G to the user.

The user identification information 264A identifies the user accessing the server 20 by using the user-side communication device 30. The user name 264B identifies a registered name of each user. The location 264C indicates the location of the user-side communication device 30 identified by an address specified by the user or a positional information transmitted from the user-side communication device 30.

The favorite store information 264D indicates a sponsor specified by the user as favorite setting. The search criteria 264E indicates a keyword registered on the server 20 by the user for searching the sponsor. The access history 264F indicates a history (e.g. including the most recently accessed date and time) that the user accesses on the website managed by the server 20. The notification 264G to the user indicates a setting of the notification noticed from the server 20 to the user-side communication device 30. For example, if the setting of the notification is “ON,” the information updated by the sponsor is notified from the server 20 to the user-side communication device 30 when the sponsor specified on the favorite store information 264D by the user updates the information. In addition, the information of the sponsor located near the location of the user-side communication device 30 indicated by the location 264C is notified from the server 20 to the user-side communication device 30, for example.

### <B3. Data Structure of Calendar Information 266>

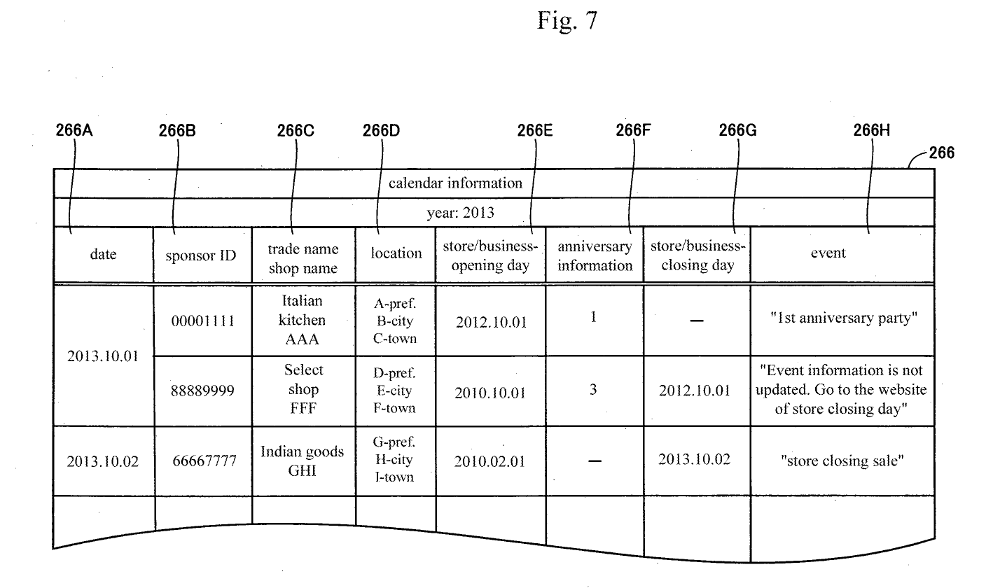

FIG. 7 is a drawing showing a data structure of the calendar information 266. As shown in FIG. 7, the calendar information 266 memorized in the memory section 206 of the server 20A includes a date 266A, a sponsor identification information 266B, a store/business-name information 266C, a location 266D, a store/business opening day 266E, an anniversary information 266F, a store/business closing day 266G and an event information 266H.

The date 266A indicates a date in the calendar of each year. In the calendar information 266, 365 cells corresponding to the date of the calendar are prepared for each year. Although a leap year has 366 days, it is considered to be rare that the company or the store uses a leap day as the store/business-opening day or the anniversary day because the store/business-opening day and the anniversary day are the date that comes every year. Accordingly, the number of the cells of each year is 365.

The sponsor identification information 266B indicates the sponsor having the memorial day such as the store/business-opening day, the anniversary day and the store/business closing day on the date indicated by the date 266A. The store/business-name information 266C indicates a name such as a trade name and a shop name of each sponsor. The location 266D indicates a location (e.g. address of the store) related to the sponsor.

The store/business opening day 266E indicates the opening day of the sponsor. The anniversary information 266F indicates the number of the year (information of the anniversary) passed after the opening day of the sponsor. The store/business closing day 266G is an estimated date of closing the store of the sponsor. The date is estimated by the server 20 based on the date that the sponsor actually closed the store or the update status of the event information transmitted from the sponsor-side communication device 10. The event information 266H indicates the event information registered from the sponsor-side communication device 10.

For example, when the server 20 receives the registration of the store/business-opening day, the store/business closing day of the sponsor or the like from the sponsor-side communication device 10, the server 20 refers to the calendar information 266 and registers the identification information of the sponsor or the like on the cell of the corresponding date of the store/business-opening day or the store/business closing day. In addition, when the server 20 receives the registration of the store/business-opening day of the sponsor from the sponsor-side communication device 10, the server 20 specifies by calculation the anniversary day of the next and subsequent years based on the date of the store/business-opening day. The server 20 registers the identification information of the sponsor, the information of the anniversary and other information on the cell of the date corresponding to the anniversary day of the calendar of the next and subsequent years. For example, if the store/business opening day of the sponsor is “2012. 10. 01,” the server 20 specifies the anniversary day of the next and subsequent years by calculation corresponding to the date (Oct. 1, 2012). For example, the server 20 calculate the first anniversary date of “2013. 10. 01” and registers the number of the year “1” on the information of the sponsor and the anniversary information 266F in association with the cell of the calendar of the calculated anniversary day. The anniversary days of the next and subsequent years are calculated in the same way, and the values are stored in the information of the sponsor and the anniversary information 266F in association with the cell of the calculated date.

Since there is a possibility that the sponsor closes the store/business, the server 20 refers to the event registration day 261G When the sponsor does not update the event information (event information 261F) for a predetermined period, the server updates the store/business closing day 266G to indicate a possibility that the sponsor closed the store. (For, example, the event information is judged not to be updated when the predetermined period has passed after the most recently date and time accessed from the sponsor-side communication device 10 to the server 20 or when no update has registered from the sponsor-side communication device 10 to the event information during the predetermined period before the current date and time.) For example, the server 20 successively judges the update status whether or not the event information of each sponsor is updated. Thus, when the server 20 judges that there is no update of the event information from the sponsor for the predetermined period, the judged timing is assumed as the store/business closing day of the sponsor.

### <C. Operation and Screen Example>

Then, operations of the devices constituting the delivery system will be explained. Hereafter, a process (1) that the sponsor-side communication device 10A receives the input operation to register the information of the sponsor on the server 20A, and the server 20 updates the sponsor management information 261 according to the input operation of the user will be explained. In addition, a process (2) that the user-side communication device 30A transmits the keyword for searching the sponsor to the server 20, the server 20 searches the sponsor based on the sponsor management information 261, and the server 20 responses the website for transmitting the information of the store/business opening day, the anniversary day or the store/business closing day based on the update status of the event information of the sponsor will be explained. In addition, a process (3) that the server 20 receives the registration of change from the sponsor-side communication device 10A when the sponsor changes the location, and the server 20 updates the information of the store/business opening day will be explained.

### <C1. Registration of Information of Sponsor>

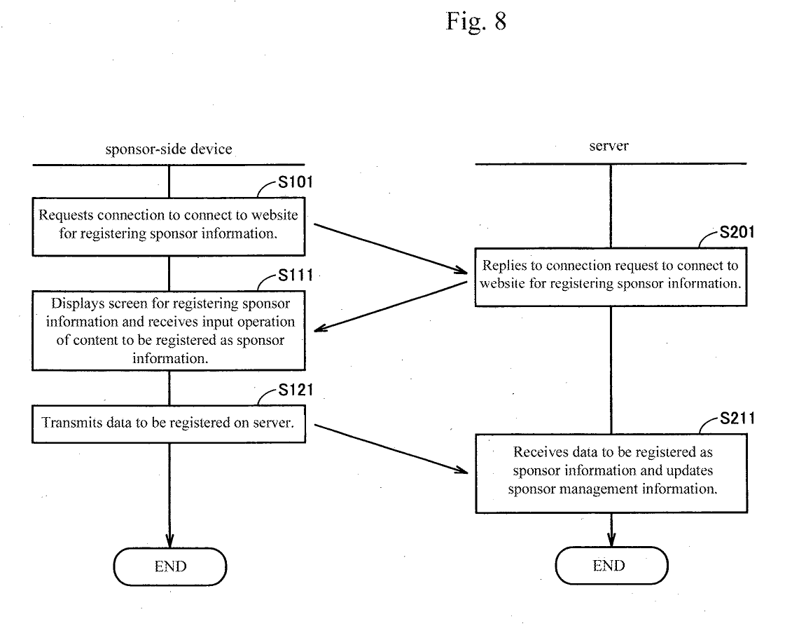

With reference to FIG. 8, the process that the sponsor-side communication device 10A receives the input operation to register the information of the sponsor on the server 20A, and the server 20A updates the sponsor management information 261 will be explained.

FIG. 8 is a flowchart showing a process that the sponsor-side communication device 10A registers the information of the sponsor on the server 20A.

In step S101, the controller 107 of the sponsor-side communication device 10A transmits a connection request to the server 20 to connect to the website provided by the server 20 for registering the sponsor information. For example, the sponsor-side communication device 10A communicates with the server 20A according to a protocol of HTTP (Hypertext Transfer Protocol) or other protocols, and receives the information of the website to display the website on the browser. The sponsor-side communication device 10A receives the input operation to log in the website by the input operation receiving section 103, and transmits the connection request to the server 20A to connect to the website.

In step S201, the server 20A receives the connection request from the sponsor-side communication device 10A to connect to the web site for registering the sponsor information, performs authentication processing of the sponsor and other processing, and responses the result of the processing to the sponsor-side communication device 10A.

In step S111, the controller 107 of the sponsor-side communication device 10A displays a screen for registering the sponsor information on the display 104 based on the data received from the server 20A using a browser or the like. The controller 107 receives, as the sponsor information, the input operation of the data to be registered on the server 20A by the input operation receiving section 103. (For example, the data can be the information for identifying the sponsor, the information indicating the store/business opening day of the sponsor, the information of the anniversary date when the existing company and store inputs the data, the event information, the information of the store/business closing day, and the information of the store opening condition when the sponsor newly plans to open the store.)

In step S121, the controller 107 transmits the data to be registered on the server 20A to the server 20A based on the received input operation.

In step S211, the controller 207 of the server 20A receives the data to be registered as the sponsor information from the sponsor-side communication device 10A, and updates the data such as the sponsor management information 261 based on the received data.

### <C2. Search of Sponsor>

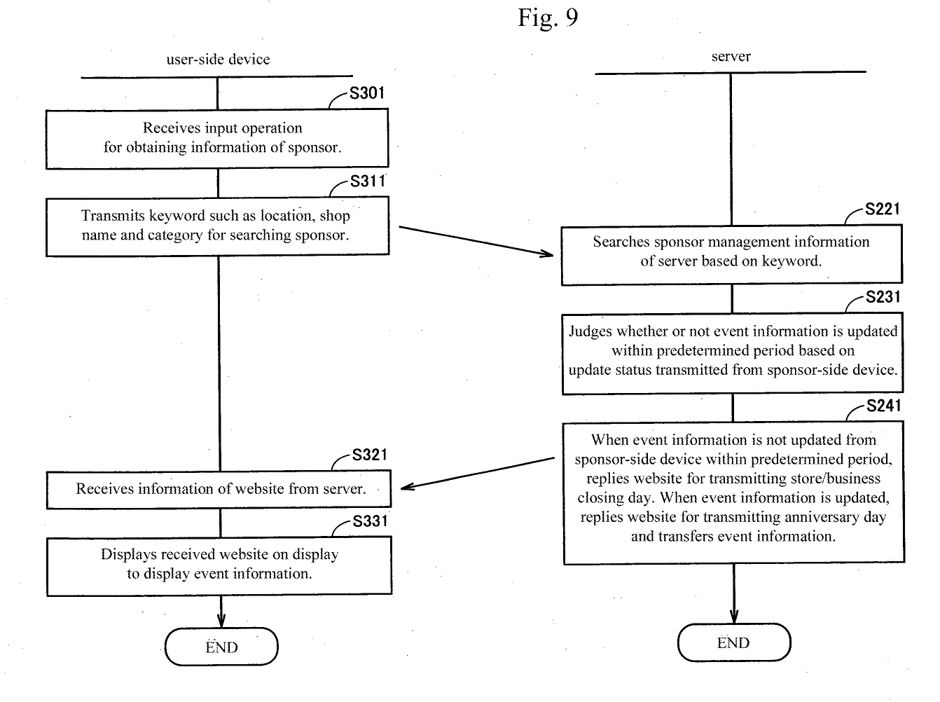

FIG. 9 is a flowchart showing a process that the user-side communication device 30A searches the sponsor in the server 20 and a process that the server 20 responses the search result to the user-side communication device 30A.

In step S301, the controller 307 of the user-side communication device 30A receives the input operation for obtaining the information of the sponsor from the user. For example, the controller 307 receives the input operation input to the browser to access the website managed by the server 20, the input operation to start the application to access the website managed by the server 20, and the input operation to input the keyword for searching the sponsor via the browser and the application from the user.

In step S311, the controller 307 transmits the keyword for searching the sponsor to the server 20. The keyword can be the location, the shop name of the sponsor, and the category of the sponsor shown in the telephone directory database, for example. For example, when the user-side communication device 30A accepts the input operation to specify the keyword for searching the sponsor from the user, the user-side communication device 30A transmits the keyword to the server 20. In addition, even if the keyword is not explicitly input by the user for example, when the application to access the server 20 is started or any other timing, the controller 307 reads the location information 363 indicating the location of the user-side communication device 30A measured by the positioning sensor 311 and the search criteria 364 preliminarily saved as the search criteria for the user to search the sponsor, and transmits the location information 363 and the search criteria 364 to the server 20.

In step S221, the controller 207 of the server 20 searches the sponsor management information 261 based on the keyword received from the user-side communication device 30, the search criteria 364 or the like.

In step S231, the controller 207 refers to the sponsor management information 261, and judges whether or not the event information is registered (updated) within the predetermined period about the keyword received from the user-side communication device 30 and the sponsor matching the search criteria 364 or the like based on the update status transmitted from the sponsor-side communication device 10A. For example, the server 20 refers to the event registration day 2610 and judges whether or not the event information 261F is registered within the predetermined period (e.g. six months) before the time of receiving the access from the user-side communication device 30.

In step S241, when the server 20 judges that the event information is not updated from the sponsor-side communication device 10A within the predetermined period, the controller 207 responses the website for transmitting the store/business closing day in addition to the information identifying the sponsor to the user-side communication device 30A since the sponsor may close the store. Alternatively, when the server 20 judges that the event information is updated within the predetermined period, the controller 207 responses the website for transmitting the store/business opening day, the website for transmitting the anniversary day or the website for transmitting the store/business closing day in addition to the information identifying the sponsor to the user-side communication device 30A according to the registration status of the store/business opening day, the anniversary day and the store/business closing day. Thus, the event information registered by the sponsor is transferred to the user-side communication device 30A.

In step S321, the controller 307 of the user-side communication device 30A receives the reply of the website from the server 20.

In step S331, the controller 307 displays the received website on the display 304, and displays the event information of the sponsor, the information of the store/business opening day, the information of the anniversary, the information of the store/business closing day and other information.

### <C3. Update Process of Store/Business Opening Day Accompanied by Location Change of Sponsor>

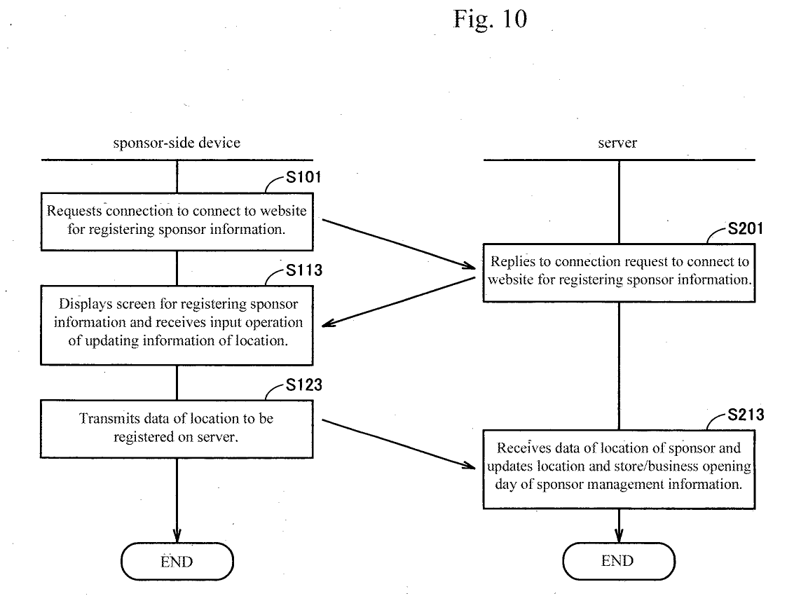

FIG. 10 is a flowchart showing a process of updating the information of the store/business opening day when the sponsor changes the location and the server 20 receives the registration of change from the sponsor-side communication device 10A. The information of the sponsor has already registered on the server 20 and the sponsor-side communication device 10A accesses to the server 20 to update the sponsor information.

In step S101, the controller 107 of the sponsor-side communication device 10A transmits the connection request to the server 20 to connect to the website provided by the server 20 for registering the sponsor information.

In step S201, the controller 207 of the server 20 receives the connection request from the sponsor-side communication device 10A to connect to the website for registering the sponsor information, performs authentication processing of the sponsor and other processing, and responses the result of the processing to the sponsor-side communication device 10A.

In step S113, the controller 107 of the sponsor-side communication device 10A displays a screen for registering the sponsor information on the display 104, and receives the input operation of updating the information of the location of the sponsor by the input operation receiving section 103.

In step S123, the controller 107 transmits the data of the location of the sponsor to the server 20 to register the data as the sponsor information.

In step S213, the controller 207 of the server 20 receives the data of the location of the sponsor from the sponsor-side communication device 10A, and updates the location 261C of the sponsor management information 261. The controller 207 updates the information of the store/business opening day of the sponsor shown in the store/business opening day/anniversary day 261E in addition to the update of the data of the location. For example, in case the event information 261F is updated in addition to the update of the location 261C, when the information of the date is included in the event information 261F, the controller 207 registers the date as the store/business opening day/anniversary day 261E presuming that the store is newly opened. In addition, when the location 261C is updated for example, the server 20 can reply the data of the input screen for selecting whether or not to update the information of the store/business opening day to the sponsor-side communication device 10A, and receive the information of the store/business opening day from the sponsor-side communication device 10A depending on the result of the reply.

### <C4. Screen Example of Registration Screen of Sponsor Information>

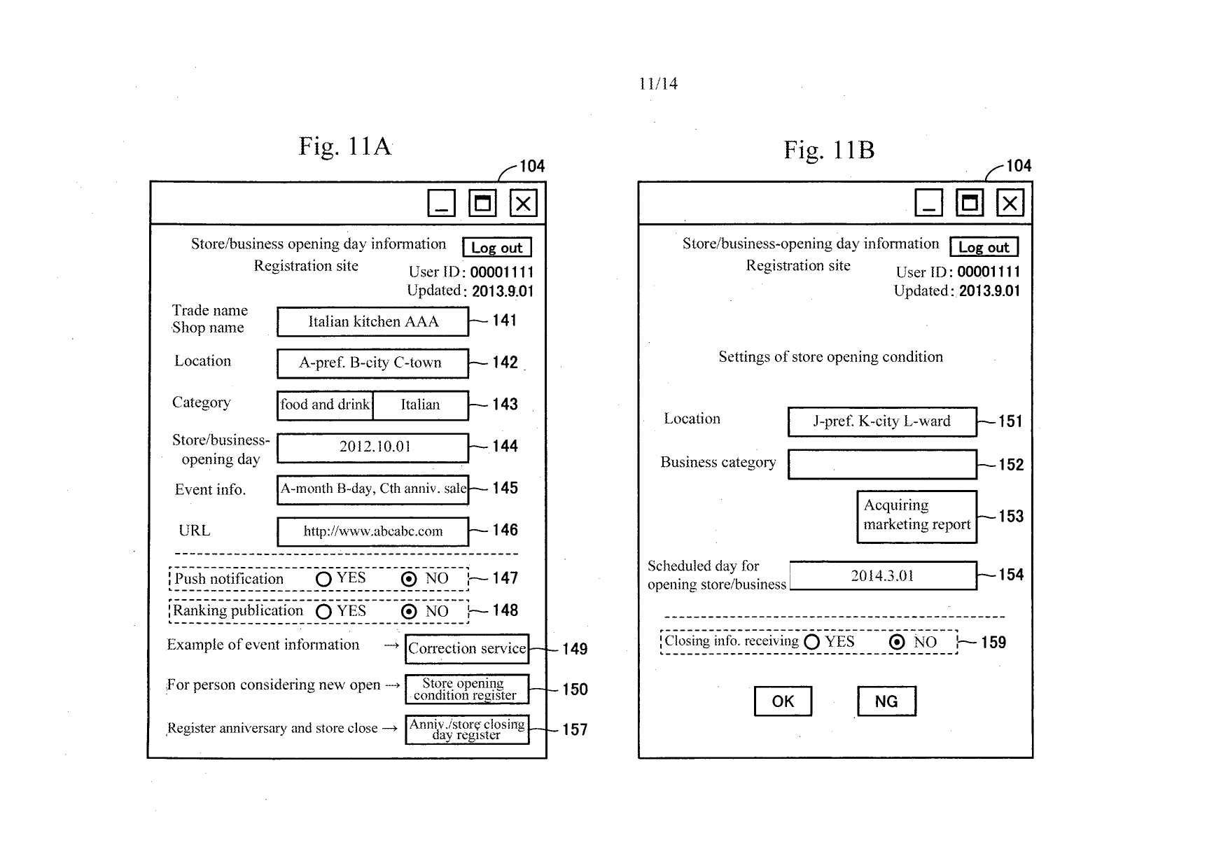

FIGS. 11A and 11B are drawings showing an example of the interface displayed on the display 104 when the sponsor-side communication device 10A registers the information of the sponsor on the server 20A. For example, this corresponds to the process of step S111 shown in FIG. 8. FIG. 11A shows a screen example for receiving the registration of the information of the sponsor. FIG. 11B shows a screen example for receiving the settings of the condition for opening new store/business of the sponsor.

As shown in FIGS. 11A and 11B, on the display 104, the sponsor-side communication device 10A displays the screens for receiving the items to register the sponsor information on the server 20A. Specifically, in order to register the sponsor information on the sponsor management information 261, the controller 107 displays a name input area 141 indicating the name of the sponsor, a location input area 142 indicating the location of the sponsor (e.g. store), a category input area 143 indicating the category of the business of the sponsor, a store/business opening day input area 144 indicating the store/business opening day of the sponsor (e.g. store), an event information input area 145 receiving the input of the event related to the memorial day such as the store/business opening day, the anniversary day and the store/business closing day, and a URL input area 146 indicating the URL of the sponsor. The input contents of each item are reflected in the sponsor management information 261. For example, the name input area 141 corresponds to the store/business-name information 261B, the location input area 142 corresponds to the location 261C, the category input area 143 corresponds to the category 261D, the store/business opening day input area 144 corresponds to the store/business opening day 261E, and the event information input area 145 corresponds to the event information 261F. The sponsor-side communication device 10A displays a registration area 157 of anniversary and store/business-closing day for receiving the input of the information of the anniversary day and the store/business-closing day from the sponsor.

The server 20 provides various services to the sponsor for delivering the event information to the user of the user-side communication device 30. The sponsor-side communication device 10A displays a push notification selecting section 147, a ranking publication selecting section 148 and a correction service selecting section 149 on the display 104. In addition, the sponsor-side communication device 10A displays a store opening condition registering section 150 for specifying the condition of opening store/business on the display 104 for encouraging the sponsor to open store/business.

The push notification selecting section 147 is a radio button for receiving the selection whether or not a push notification is enabled for notifying the event information registered by the sponsor. For example, the server 20 refers to the sponsor management information 261, specifies the location (location 261C) registered by the sponsor, and specifies the user-side communication device 30 located at the specified location by using the user management information 264.

The event information of the sponsor is transmitted to the user-side communication device 30 of the specified user via push notification. Namely, even when the user of the user-side communication device 30 does not perform an input operation to access the server 20, the information indicating the update of the event information of the sponsor is transmitted from the server 20 to the user-side communication device 30.

In addition to the location registered by the sponsor, the server 20 can specify the user-side communication device 30 that registers the corresponding sponsor as favorite setting by using the user management information 264 to transmit the event information of the sponsor to the user-side communication device 30 of the specified user via push notification. In addition, the server 20 can specify the user who specifies the category of the sponsor as the search criteria by using the search criteria 264E of the user management information 264 to transmit the event information of the sponsor to the user-side communication device 30 of the specified user via push notification.

Further, the server 20 can specify the user who frequently accesses the server 20 by using the access history 264F of the user management information 264 to transmit the event information to the user-side communication device 30 of the specified user via push notification. As explained above, the server 20 provides the service to transmit the event information to the user-side communication device 30 via push notification. Thus, the possibility that the user of the user-side communication device 30 receives the event information of the sponsor is increased.

The ranking publication selecting section 148 is a radio button that provides an option to the sponsor-side communication device 10 for pushing the ranking of the sponsor higher when listed as the search result. For example, when the user-side communication device 30 searches the sponsor based on the location or the like, the possibility accessed by the user of the user-side communication device 30 increases when the sponsor is in a higher position in the list. Thus, an option for pushing the ranking higher when listed as the search result can be provided to the sponsor.

The correction service selecting section 149 provides a service for correcting the content of the event information registered by the sponsor while judging whether or not the content is frequently viewed by the user of the user-side communication device 30. This service is provided, for example, by the business operator of the server 20 for the relevant people of the sponsor-side communication device 10. For example, when the event information is published as text, the response rate of the user of the user-side communication device 30 is assumed to vary depending on the content of the text data.

Accordingly, for example, the business operator of the server 20 provides the service to the relevant people of the sponsor-side communication device 10 to introduce successful cases of the content to be published as the event information and correct the content to be published as the event information.

The services provided by the push notification selecting section 147, the ranking publication selecting section 148 and the correction service selecting section 149 aim for improving a matching ratio between the sponsor and the user of the user-side communication device 30.

For example, the business operator of the server 20 provides the service to the relevant people of the sponsor-side communication device 10 for a fee. The user-side communication device 30 informs the push notification transmitted from the sponsor to the user as a sound output of the speaker 313, a light emitting of the emitting portion 314 or a vibration of the vibrator 315, for example.

The store opening condition registering section 150 provides an input interface to the sponsor for specifying the condition of opening store/business. In response to the input operation input to the store opening condition registering section 150, as shown in FIG. 11B, the screen for receiving the setting of the condition of opening store/business is transmitted from the server 20 to the sponsor-side communication device 10A.

The sponsor-side communication device 10A displays a store opening location 151, a business category 152, a report acquisition section 153, a scheduled day for opening store/business 154 and a closing information receiving setting 159 on the display 104. The store opening location 151 indicates a condition of the location of opening store/business. The business category 152 indicates a business category of opening store/business. The report acquisition section 153 provides for the sponsor a service that the sponsor-side communication device 10A requests to the server 20 a marketing report including a history of opening stores at the location of opening store/business, the server 20 generates the marketing report including the history of opening stores of each area based on the regional store opening history information 267 or the like according to the request, and the generated marketing report is acquired from the server 20.

The scheduled day for opening store/business 154 indicates the date of opening store/business. The closing information receiving setting 159 indicates the setting whether or not to receive the information of the store matching the condition of opening store/business when there is a store or the like to close its store/business. For example, in case the setting is made to receive the information of the store or the like to close its store/business and the condition of the location of opening store/business of the sponsor is specified on the store opening location 151, when there is a store to register the store/business closing day at the corresponding location, the information of the corresponding store is transmitted from the server 20 to the sponsor-side communication device 10A. Consequently, the sponsor can promptly acquire the information of the store closing its store/business. Thus, the sponsor can obtain the article with all its furnishings or buy the equipments equipped in the store closing its store/business, for example.

### <C5. Screen Example Displaying Store/Business Opening Day, Anniversary Day, Store/Business Closing Day and Tracking Information of Sponsor>

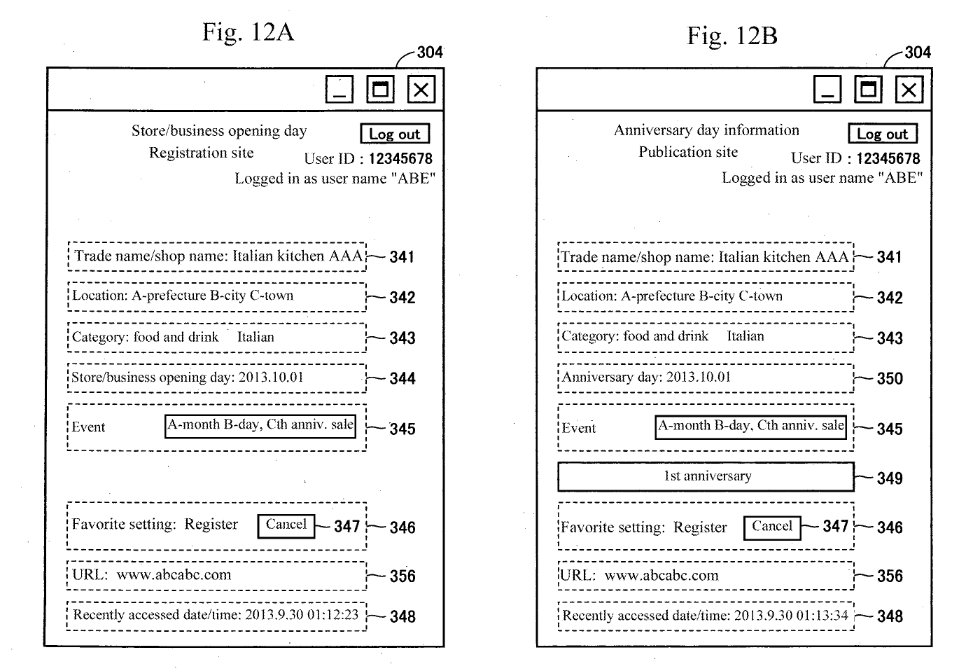

FIGS. 12A and 12B are drawings showing an example of an interface displaying the information of the store/business opening day and an interface displaying the information of the anniversary day after a user-side communication device 30 acquires the information of the sponsor. For example, this corresponds to the process of step S331 shown in FIG. 9. FIG. 12A is a display example of the website for transmitting the store/business opening day of the sponsor. FIG. 12B is a display example of the website for transmitting the anniversary day of the sponsor.

As shown in FIG. 12A, the user-side communication device 30 displays the website for transmitting the store/business opening day of the sponsor on the display 304. The user-side communication device 30 displays, based on the data received from the server 20, a name display area 341 indicating the name of the sponsor, a location display area 342 indicating the location of the sponsor, a category display area 343 indicating the category of the sponsor, a store/business opening day display area 344 indicating the store/business opening day of the sponsor and an event information display area 345 indicating the event information registered by the sponsor.

In addition, the user-side communication device 30 displays on a favorite setting display area 346 whether or not the sponsor is registered as favorite setting by the user of the user-side communication device 30, and receives an operation to turn on/off the favorite setting by a favorite setting input area 347. The user-side communication device 30 displays an accessed time that the user accessed the server 20 on an accessed time display area 348. A URL 356 displays a URL for accessing the website of the sponsor, for example.

As shown in FIG. 12B, the user-side communication device 30 displays the website for transmitting the anniversary day of the sponsor on the display 304. An anniversary information display area 349 indicates an anniversary year of the sponsor. An anniversary day display area 350 indicates an anniversary day of the sponsor. The server 20 refers to the event registration day 261G of the sponsor management information 261, and responses the website for transmitting the information for transmitting the information of the anniversary to the user-side communication device 30 (step S241) since the event information is registered within the predetermined period before the accessed time. For example, the server 20 displays the information of one of the store/business opening day and the anniversary day to display the information of the day closest to the time accessed by the user.

In the example of FIG. 12B, referring to the sponsor management information 261, the store/business opening day of the sponsor name “Italian kitchen AAA” is the store/business opening day “Oct. 1, 2012.” The time accessed from the user-side communication device 30 to the server 20 is the accessed date “Sep. 30, 2013,” the anniversary date “Oct. 1, 2013” is responded as the anniversary date.

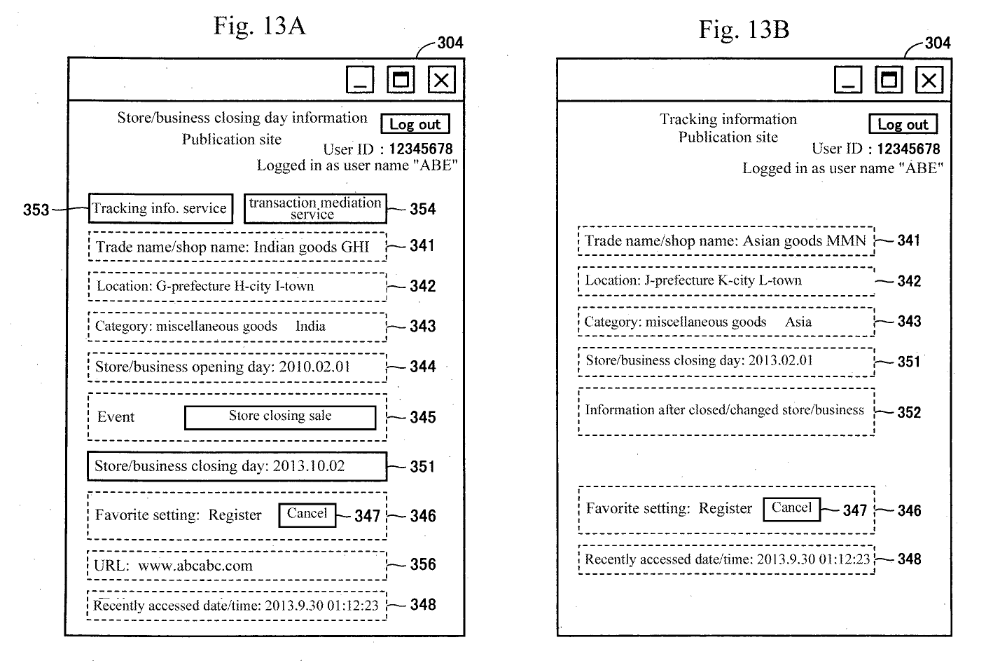

FIGS. 13A and 13B are drawings showing an example of an interface displaying the information of the store/business closing day and an interface displaying a tracking information after the user-side communication device 30 acquires the information of the sponsor. FIG. 13A is a display example of the website for transmitting the store/business closing day of the sponsor. FIG. 13B is a display example of the web site for transmitting the tracking information of the sponsor.

As shown in FIG. 13A, the user-side communication device 30 displays the website for transmitting the store/business closing day of the sponsor on the display 304. The user-side communication device 30 displays a store/business closing day display area 351 indicating the store/business closing day of the sponsor based on the data received from the server 20. In addition, the user-side communication device 30 displays a tracking information service acceptation area 353 for providing the user the tracking information following up the information of the sponsor who closes the store. The user-side communication device 30 displays a transaction mediation service acceptation area 354 for providing a platform to transact the property such as a store and equipments equipped in the store with the sponsor who closes the store.

The information following up the sponsor who closes the store means, for example, whether or not the sponsor closes the business, whether or not the sponsor changes the business category, and a storage state and a moving state of the resource when the sponsor closes the store. (The resource includes physical resources such as fixtures and equipments and human resources such as employer and employee. The server 20 receives the registration of the tracking information of each sponsor from a third party or the sponsor. The user-side communication device 30 receives an input operation input to the tracking information service acceptation area 353, and requests the tracking information to the server 20. The server 20 performs authentication processing and then responses the website for transmitting the tracking information to the user-side communication device 30 according to the request of the tracking information.

As shown in FIG. 13B, the user-side communication device 30 displays the website for transmitting the tracking information on the display 304. The user-side communication device 30 displays the tracking information on a tracking information display area 352 based on the data received from the server 20.

Consequently, the information about the closing of the store of the sponsor can be provided for a person who desires to collect the fixtures and equipments of the sponsor and a person who desires to receive an introduction of human resources such as the relevant people of the sponsor, for example. Namely, the sponsor who closes the store and the person who desires to collect the fixtures and equipments of the sponsor can be easily matched with each other, for example.

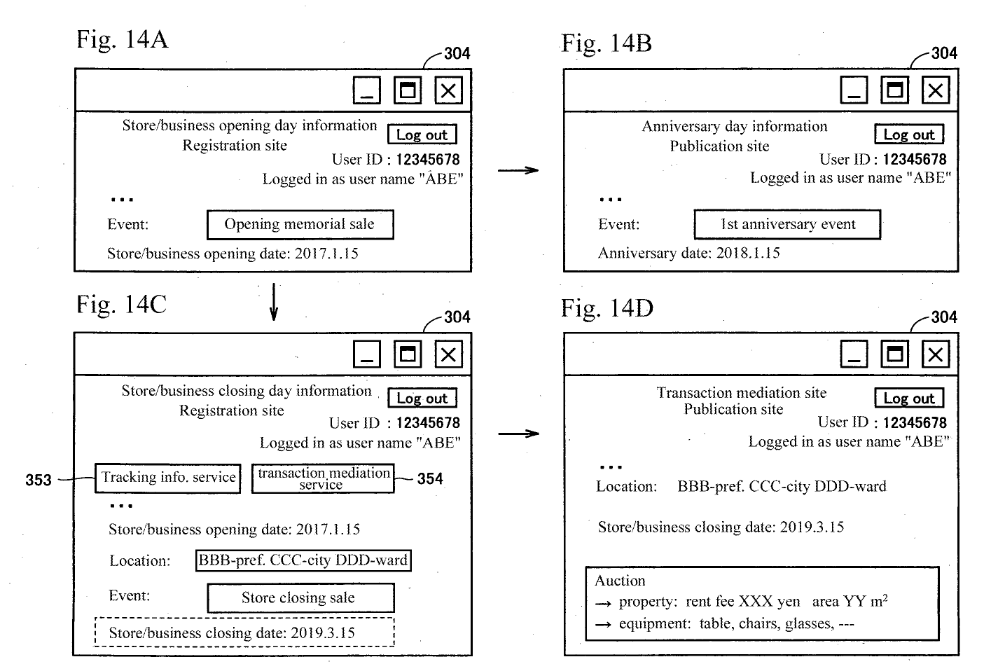

FIGS. 14A to 14D are drawings showing an example of the website responded from the server 20 to the user-side communication device 30 according to the update status of the sponsor. FIG. 14A shows an example of the interface displaying the information of the store/business opening day of the sponsor and the event information related to the store/business opening day. (Although the information of the sponsor such as the name or the location of the sponsor is displayed on the website, the store/business opening day is displayed in FIG. 14A as an example.)

Then, the sponsor updates the information related to the anniversary day and transmits the event information. The server 20 responses the website for transmitting the information of the anniversary day to the user-side communication device 30 (step S241). FIG. 14B shows an example of the interface displaying the information of the anniversary day of the sponsor and the event information related to the anniversary day.

However, when the event information of the anniversary day is not registered to the server 20 by the sponsor within the predetermined period, the sponsor may close the store. The server 20 responses the website for transmitting the information of the store/business closing day to the user-side communication device 30 (step S241). FIG. 14C shows an example of the interface displaying the information of the store/business closing day of the sponsor, the event information related to the store/business closing day, and operation buttons for transmitting the tracking information from the server 20 to the user-side communication device 30. FIG. 14D shows an example displaying the website for providing a platform for receiving an input operation input to the transaction mediation service acceptation area 354 by the user-side communication device so as to transact the property of the closing store and equipments equipped in the store with the sponsor who closes the store when the sponsor closes the store. If the website shown in FIG. 14D is displayed on the sponsor-side communication device 10, the sponsor who plans to newly open store/business and the sponsor who desires to close the store can be matched with each other. Thus, an initial cost of the sponsor who plans to open store/business can be reduced, and a withdrawal cost of the sponsor who closes the store can be reduced.

Although the transaction mediation service acceptation area 354 is displayed on the display 304 in FIG. 14C, the transaction mediation service acceptation area 354 can be specified to be available when the sponsor specifies and registers the store/business-closing day on the server 20. For example, as explained in step S241 of FIG. 9, when the event information is not updated from the sponsor-side communication device 10A within the predetermined period, the website for transmitting the store/business-closing day is transmitted from the server to the user-side communication device 30 or the like since the sponsor may close the store or the like. In this case, the sponsor may not voluntarily register the store/business-closing day. Thus, the sponsor may not intend to transfer the property or the like about the closing store/business. On the contrary, when the sponsor registers the store/business-closing day on the server 20, the sponsor intends to withdraw from the management of the store or the like and the transaction mediation service acceptation area 354 can be enabled.

### CONCLUSION

(1) The server 20A manages a first website for transmitting the information of the anniversary day and a second website for transmitting the information of the store/business closing day. The controller 207 of the server 20A receives a request to transmit the information related to the sponsor from the user-side communication device 30A, transmits the first website as the information of the anniversary day to the user terminal by the anniversary information delivery section 274 when the event information of the corresponding sponsor is updated by the sponsor-side communication device 10A within the predetermined period, and transmits the second website as the information of the store/business closing day (information indicating possibility of closing store/business of sponsor) to the user terminal by the store closing information delivery section 275 when the event information of the corresponding sponsor is not updated by the sponsor-side communication device 10A within the predetermined period. The reception processing section 372 of the controller 307 of the user-side communication device 30A receives the first website as the information of the anniversary day and receives the second website as the information of the store/business closing day. The display processing section 373 displays the information of the website received from the server on the display 304.

(2) The server 20A memorizes the location 261C of the sponsor while associating the sponsor management information 261 with each of the sponsor information. The input operation receiving section 103 of the sponsor-side communication device 10A receives the input operation to register the information indicating the location of the sponsor on the server in association with the information identifying the sponsor. The wireless communication section 102 transmits the information indicating the location received by the input operation to the server 20A as the registered contents. When the controller 207 of the server 20A receives the information indicating the location of the sponsor from the sponsor-side communication device 10A, the received location is memorized in association with the sponsor of the sponsor management information 261. When the location 261C memorized in the sponsor management information 261 is changed, the controller 207 updates the information of the store/business opening day of the sponsor based on the time when the location is changed.

(3) By using the delivery system explained in the above embodiment, various business opportunities (e.g. increase of new customers, repeatedly coming customers, introduction of new menus for customers, stock control of commodities) can be provided for the sponsor such as the company and the store. Furthermore, loss of customers and economic loss caused by the temporary/permanent closing or movement of the company or the store can be avoided and the customer can be led to newly opened store/business. The embodiment disclosed here is merely an example in all respects and the embodiment should be considered not to limit the invention. The range of the invention is shown in the claims not in the above explanation. All variations equivalent to the claims in range and meaning are intended to be included in the claims.

### DESCRIPTION OF THE REFERENCE NUMERALS

10 . . . sponsor-side communication device, 20 . . . server, 30 . . . user-side communication device

1. A delivery system, comprising:
a server;
a sponsor terminal; and
a user terminal, wherein
the server includes:
a communication interface for accepting an access from the sponsor terminal or the user terminal to transmit/receive data to/from the sponsor terminal or the user terminal;
a memory for storing, in a respective cell of dates of a calendar, an information identifying a sponsor, an information of a store/business opening day of the sponsor, an event information of the store/business opening day, and an event information of an anniversary date of the next and subsequent years of the store/business opening day, the information identifying the sponsor and the information of the store/business opening day of the sponsor being in association with each other; and
a first processor for controlling an operation of the server and transmitting the event information to the user terminal,
the sponsor terminal includes:
an input interface for receiving an input operation to register in the server the information identifying the sponsor, the information of the store/business opening day of the sponsor, the event information of the store/business opening day to be transmitted to the user terminal; and
a communication unit for transmitting contents registered by the input operation to the server,
the user terminal includes:
a display;
a communication section; and
a second processor for controlling an operation of the user terminal, wherein
the first processor of the server has functions of:
a registration processing section for receiving the information of the store/business opening day from the sponsor terminal, recording a date of the store/business opening day and the information identifying the sponsor in the memory in association with each other, specifying the anniversary date of at least the next and subsequent years of the store/business opening day by calculation, and recording the specified anniversary information indicating the anniversary date in the cell of the dates of the calendar;
a store opening information delivery section for transmitting the information of the store/business opening day, the information identifying the sponsor related to the store/business opening day and the event information of the store/business opening day to the user terminal; and
an anniversary information delivery section for transmitting the anniversary information and the event information of the anniversary date to the user terminal,
the second processor of the user terminal has functions of:
a reception processing section for receiving the information of the store/business opening day and the anniversary information from the server; and
a display processing section for displaying the received information on the display.

2. The delivery system according to claim 1, wherein
the sponsor terminal receives the input operation to register in the server the information identifying the sponsor, the anniversary date of the sponsor and the event information of the anniversary date to be transmitted to the user terminal by the input interface,
the registration processing section of the first processor of the server receives the information registered by the sponsor terminal from the sponsor terminal, records in the memory the anniversary information indicating the date of the anniversary of the sponsor, the information identifying the sponsor and the event information of the anniversary date in association with each other, and specifies the anniversary date of the store/business opening day in at least the next and subsequent years of the store/business opening day by calculation, and
the anniversary information delivery section transmits the anniversary date registered as the anniversary information or the anniversary date in at least the next and subsequent years of the registered anniversary date and the event information of the anniversary date to the user terminal.

3. A delivery system, comprising:
a server;
a sponsor terminal; and
a user terminal, wherein
the server includes:
a communication interface for accepting an access from the sponsor terminal or the user terminal to transmit/receive data to/from the sponsor terminal or the user terminal;
a memory for storing, in a respective cell of dates of a calendar, an information identifying a sponsor, an anniversary information indicating an anniversary date after a predetermined number of years of a store/business opening day of the sponsor, and an event information of the anniversary date in association with each other; and
a first processor for controlling an operation of the server and transmitting the event information to the user terminal,
the sponsor terminal includes:
an input interface for receiving an input operation to register in the server an information identifying the sponsor, an information of the anniversary date of the sponsor, the event information of the anniversary date; and
a communication unit for transmitting contents registered by the input operation to the server,
the user terminal includes:
a display;
a communication section; and
a second processor for controlling an operation of the user terminal, wherein
the first processor of the server has functions of:
a registration processing section for receiving the information of the anniversary date of the sponsor from the sponsor terminal, recording the received anniversary date and the information identifying the sponsor in the memory in association with each other, specifying the anniversary date of at least the next and subsequent years of the received anniversary date by calculation, and recording the specified anniversary date in the cell of the dates of the calendar; and
an anniversary information delivery section for transmitting the registered anniversary date or the anniversary date of at least the next and subsequent years specified by the registered anniversary date and the event information of the anniversary date to the user terminal,
the second processor of the user terminal has functions of:
a reception processing section for receiving the information of the anniversary date from the server; and
a display processing section for displaying the received information on the display.

4. The delivery system according to claim 1, wherein
the first processor of the server has a function of:
a store closing information delivery section for transmitting an information indicating a possibility of closing store/business of the sponsor to the user terminal when the input operation of the event information is not received from the sponsor terminal for a predetermined period of time,
the reception processing section of the second processor of the user terminal has a function of receiving the information indicating the possibility of closing store/business of the sponsor, and
the display processing section has a function of displaying the information indicating the possibility of closing store/business on the display.

5. The delivery system according to claim 1, wherein
the input interface of the sponsor terminal receives the input operation to register an information of a store/business closing day on the server, the information of the store/business closing day being specified by the sponsor,
the registration processing section of the first processor of the server receives the information of the store/business closing day from the sponsor terminal and records the received date of the store/business closing day and the information identifying the sponsor in association with each other, the information of the store/business closing day being registered on the sponsor terminal and specified by the sponsor,
the first processor of the server has functions of:
a store closing information delivery section for transmitting the information of the store/business closing day specified by the sponsor to at least one of the user terminal and the sponsor terminal when the date of the store/business closing day is recorded in the memory; and
a site information transmitting section for transmitting an information of a URL (Uniform Resource Locator) that enables a user to access a service site to at least one of the user terminal and the sponsor terminal, the service site providing a service mediating a transaction with the sponsor closing the store/business.
